(19) United States
(12) Patent Application Publication
(10) Pub. No.: US 2022/0188358 A1
(43) Pub. Date: Jun. 16, 2022

(54) TECHNIQUE FOR AGGREGATING CONTENT FROM A COMMON GRAPH EDGE

(71) Applicant: Microsoft Technology Licensing, LLC, Redmond, WA (US)

(72) Inventors: James Hung, Cupertino, CA (US); Samson Hin-Leung CHOI, Sunnyvale, CA (US); Fangbing QIU, San Francisco, CA (US); Collin Dang YEN, Saratoga, CA (US); Heyang LIU, Santa Clara, CA (US); Xiang LIN, Fremont, CA (US); Garrett Gabriel WELSON, Cupertino, CA (US); Kangning HU, Bloomfield, NJ (US); Ying XUAN, Sunnyvale, CA (US); Yanbin JIANG, Sunnyvale, CA (US); Diya Dutt SHARMA, San Francisco, CA (US); Manas Haribhai SOMAIYA, Sunnyvale, CA (US)

(21) Appl. No.: 17/118,368

(22) Filed: Dec. 10, 2020

(51) Int. Cl. G06F 16/901; G06F 16/9032; G06F 16/9038; G06F 16/904; G06F 16/908

(52) U.S. Cl. CPC G06F 16/9024; G06F 16/90328; G06F 16/908; G06F 16/904; G06F 16/9038

(57) ABSTRACT

Described herein are techniques for processing content items for presentation via a content feed of an online service. Upon receiving a request associated with a particular end-user of an online service for a content feed, a connection graph is analyzed to identify a plurality of content items that are eligible for presentation to the end-user. Some subset of content items that share a common relationship with the end-user, as indicated by a common edge in the connection graph, are identified. This subset of content items is then grouped together for presentation within the content feed in a content carousel, where the content carousel is positioned within the content feed, relative to other content items, based on the highest ranking content item presented via the content carousel.

### TECHNICAL FIELD

The present application generally relates to data processing and presentation techniques for a content feed. More precisely, the present application describes a specific technique to improve the computational efficiency with which content is processed and presented via a content feed, by aggregating content items that share some common characteristic with respect to a connection graph, such as being associated with a common graph edge.

### BACKGROUND

Content feeds have become one of the hallmark features of many popular Internet or web-based services. By way of example, many different Internet services, such as social networking services, e-commerce and marketplace sites, photo sharing sites, news sites, dating sites, and so on, utilize some form of a content feed to present end-users with relevant content. What is referred to herein as a content feed may also be known as a data feed, news feed, product feed, web feed, or simply, a feed. In many instances, the content items that are presented to an end-user of a content feed are selected for presentation to the end-user based on the end-user having previously taken some explicit and specific action to indicate some association or relationship with some aspect of the content item. By way of example, in a social networking service, content items that are published to a content feed by a first member may be presented to a second member when the second member has previously taken some specific and explicit action to establish a formal relationship (e.g., “connection” or “friend”) with the second member. Accordingly, when two members are connected with one another via a social graph maintained by the online service, when a first member publishes content to a content feed, the published content item may be selected for presentation to the second member, via the content feed. Similarly, in the context of a photo sharing site, a first end-user may choose to subscribe to, or “follow,” a second end-user, such that photographs shared by the second end-user will be presented in a content feed to the first end-user only after the first end-user has subscribed to or followed the second end-user.

These formally recognized associations and/or relationships that exist between content items and end-users are generally memorialized in a database maintained by the online service, for example, such as a graph database. A graph database is a special type of database that stores data in a way that recognizes that the importance of the association or relationship between data is often as important as the data itself. These associations and relationships are often conveyed visually as a graph—for example, a plot of nodes and edges, where an edge connecting two nodes represents some type of association or relationship between the particular entities that are represented by the nodes. While a graph of this type is referred to herein as a connection graph, it may also be referred to as a social graph, a connectivity graph, a content graph, or simply a graph, depending upon the specific service or site and the nature of the entities that are represented by the individual nodes. For instance, an e-commerce site may utilize a connection graph with nodes representing end-users (e.g., customers or potential customers), categories of products, brands, and/or individual products. Similarly, asocial graph is a special type of connection graph that is associated with a social networking service. A social graph may have nodes representing people, companies or other organizations, as well as topics to which content items are assigned. Accordingly, the edges connecting the nodes may represent a particular association or relationship between two people, between a person and an organization, or a person's interest in a topic, and so forth.

### BRIEF DESCRIPTION OF THE DRAWINGS

Embodiments of the present invention are illustrated by way of example and not limitation in the figures of the accompanying drawings, in which:

FIG. 1 is a diagram showing an example of the operations conventionally used to select and present content items in a content feed;

FIG. 2 is a diagram showing an example of an improved technique for processing content items for presentation via a content feed, consistent with embodiments of the present invention;

FIG. 3 is a diagram illustrating an example of a connection graph, as maintained in a database as part of an online service, consistent with embodiments of the invention:

FIG. 4 is a flowchart diagram illustrating an example of the operations for selecting, processing and presenting content items in a content feed, consistent with embodiments of the invention;

FIG. 5 is a user interface diagram illustrating an example of a user interface in which a content feed is presented, consistent with embodiments of the present invention; and

FIG. 6 illustrates a diagrammatic representation of a machine in the form of a computer system within which a set of instructions may be executed for causing the machine to perform any one or more of the methodologies discussed herein, according to an example embodiment.

### DETAILED DESCRIPTION

Described herein are methods and systems for efficiently processing and presenting content items in a content feed, such that content items that share a common edge within a connection graph are aggregated for presentation together within the content feed. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

For purposes of the present application, a content feed is a computer-implemented application or service having a user interface by which content items are presented to end-users of an online service or system. A content feed is sometimes referred to as a news feed, product feed, or simply, a feed. A content feed may be vertically scrolling, such that additional content items can be accessed when the end-user causes the user interface to scroll in an upward/downward direction in relation to the top and bottom of the display. Similarly, a content feed may be horizontally scrolling, such that additional content items may appear to the right or left, in relation to the top/bottom of the display. The nature of the content items presented via a content feed will vary significantly depending upon the application or service with which the content feed is integrated. With many content feeds, the content of each content item is generally structured with individual data fields. For example, separate data fields may be used to specify the author/source of the content, a title, a topic, a brand of a product, and so forth.

Content feeds may present content items that have specifically been designated as having certain content types. Again, the various content types may vary significantly from one context to another, for example, depending upon the nature of the system or service with which the content feed is integrated. In the example of a social networking service, content items may be generally characterized as system-generated content, or user-generated content. By way of example, in the context of a social networking service, system-generated content may include insights regarding an end-user's profile. For example, a system-generated content item may be presented to an end-user to notify the end-user that one of his connections has had a job anniversary (e.g., a connection has been in the same job position with the same company for one or more years), or, has recently added a new job position to his or her profile. Another type of content item that may be characterized as a system-generated content item is an advertisement, including advertisements that specifically reference available job openings, which are generally referred to as job listings or job postings. User-generated content items include the sharing of articles or blog postings hosted by any of a wide variety of third-party sites. Such content items generally include the content of the referenced article or blog posting, but also any commentary provided by the end-user. Of course, user-generated content may include content that is entirely generated by an end-user, without reference to content hosted by a third-party site.

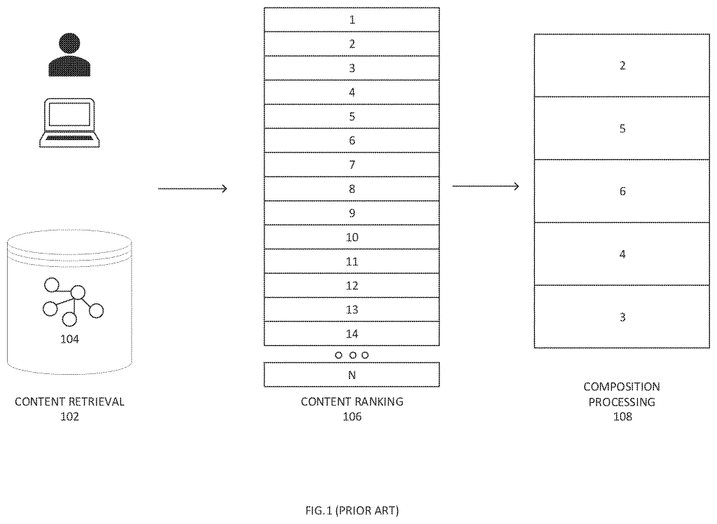

As illustrated in FIG. 1, with a conventional content feed, there are generally three individual steps involved in preparing a content feed for presentation to an end-user. First, when the end-user of an online service elects to view his or her content feed, a content retrieval operation 102 occurs. During the content retrieval operation 102, content items that are eligible for presentation to the end-user are identified or selected. Generally, a connection graph 104 as memorialized in a database is evaluated to determine content items to which the end-user has some association or relationship. For example, in the specific context of a social networking service, the connection graph may indicate other end-users of the social networking service with whom an end-user has established a formal connection, or other end-users that the end-user has elected to follow. Content created and/or published by this group of end-users is eligible for presentation to the end-user in his or her content feed. Similarly, the connection graph may identify topics in which an end-user has explicitly expressed interest. Such interest may be explicitly expressed when an end-user elects to follow a particular metadata tag (e.g., such as a hashtag in the form, “#topic,” where the topic designates a particular subject matter) that can be assigned to content items to indicate their relevance with respect to the topic designated by the tag. By analyzing the connection graph, content items satisfying certain characteristics (e.g., connected to the end-user via certain edges within the graph) that make those content items eligible for presentation to the end-user are identified. The end result of this first phase is a large—for example, in some instances, tens of thousands, or more —candidate pool of content items eligible for presentation to the end-user.

Next, after the content retrieval phase 102, content ranking 106 occurs. The criteria used to rank the retrieved content items will vary significantly depending upon the nature of the content and the context in which the content feed is presented. By way of example, in the context of a social networking service, the criteria used to rank the content items may include information indicating the relevance or importance of the content item to the end-user, as well as the date/time at which the content was initially posted, with a general preference being to present more current content items. In any case, the result of the content ranking phase 106 is a ranked set of content items eligible for presentation to the end-user. As illustrated in the example shown in FIG. 1, each content item in the ranked set of content items is represented by a rectangle with a number indicating its ranking score relative to the other content items, such that the highest ranking content item (with a ranking score of one (“1”)) is presented at the top.

Next, in the third phase, composition processing 108 occurs. The composition processing involves the application of a set of rules used to enhance the order in which content items appear in the final presentation of the content feed. Again, the specific rules that are used in the composition processing phase may vary considerably depending upon the specific nature of the content items and the context in which the content feed is being presented. Generally, one set of composition processing rules may involve what might be referred to as diversity rules intended to ensure that the content feed provides a diverse set of content items. In this context, diversity may be measured based on content types, content sources, and/or content topics. By way of example, in the context of a social networking service, during the composition processing phase, the ranked list of content items may be iteratively processed to ensure that there is a minimum number of content items that separates two content items that share some common characteristic (e.g. type/source/topic). For example, it may be desirable to separate content items that have been published by the same source (e.g., the same end-user), or published on behalf of the same company or organization. Similarly, it may be desirable to separate content items that relate to the same topic, or, have the same content type (e.g., advertisements, job updates, job postings, and so forth). Separating content items by some minimum number of other content items when presenting the content items in the content feed will provide greater diversity of content, and thus improve the overall end-user experience.

Additionally, during the composition processing 108, ranked content items that have recently been presented to the end-user, whether via the content feed or perhaps in some other context, may be identified for exclusion from the content feed. Such content items may be eliminated from the final set of content items presented to the end-user in order to improve the end-user experience by presenting new (e.g., previously unseen) content items to the end-user. As illustrated in the example of FIG. 1, the result of the composition processing 108 is a revised ranked list of content items that satisfies one or more rules or constraints, enforced during the composition processing phase. In this example as shown in FIG. 1, note that the content item with rank three (“3”) has been moved to a lower position in the content feed, so that three other content items separate the second and third highest ranking content items. That is, three content items separate the first content item, with a ranking score of two (“2”), and a second content item with a ranking score of three (“3”). This may have occurred because the two content items are associated with the same edge in a connection graph, indicating that the content items are from the same source, or relate to the same topic. Various embodiments may have different thresholds for the minimum number of content items that are required to appear between similar content items—that is, content items sharing a common source, content items related to the same topic, or, content items of the same type, and so forth.

One of the problems with a conventional content feed is that content items that share some common characteristic are separated within the content feed, either as a result of their respective rankings or by virtue of applying the rules of the composition processing stage. For example, if an end-user has previously expressed interest in a particular topic, for example, by electing to follow any content that has been assigned a particular metadata tag, the content items that relate to this topic of interest will likely be separated by other content items when presented in the content feed. By way of example, in FIG. 1, the content item with rank two (“2”) and the content item with rank (“3”) may be related to the same topic. However, as a result of applying a rule during the composition processing phase, the two content items are separated by three other content items when presented in the content feed. Separating content items that share some common characteristic—particularly, content items that share a common edge connecting the content items to the end-user as memorialized in a connection graph maintained by the online service—may be a source of irritation to the end-user.

Additionally, processing the content items during the composition processing 108 phase is a computationally expensive process. As previously mentioned, the ranked list of content items may include tens of thousands of individual content items. Enforcing one or more rules that require content items sharing some common characteristic to be separated by some minimum number of other content items when presented in the final presentation of the content feed is computationally very expensive, as the rule(s) must be iteratively applied, and re-applied. For example, when a content item is re-positioned within the content feed as a result of some rule during the composition processing 108 phase, this may result in the violation of some other rule or constraint. Accordingly, after repositioning a content item, the order of the content items must continually be reassessed until all of the composition processing rules are satisfied.

In addition to being computationally expensive, presenting each content item that shares a common edge in a connection graph separately within the content feed increases the overall amount of data that must be communicated from the server to the client when generating the user interface for the content feed. For instance, content items are generally semi-structured with separate data fields indicating, for example, the source of the content (e.g., the name of the end-user who generated or shared the content), a title or subject line, or, one or more metadata tags (e.g., hashtags), and so forth. As many content items share in common information associated with one or more of these specific data fields, presenting each content item as a separate content item in the content feed requires that the information associated with each data field of each content item be communicated separately from the server to the client device. If a computer network has limited bandwidth, communicating all of the data to generate the user interface of the content feed at the client device may take a sufficiently long time that the end-user perceives a delay. Any such perceived delay in the time between requesting information, and being presented with the information, can be an extreme annoyance and frustration to the end-user.

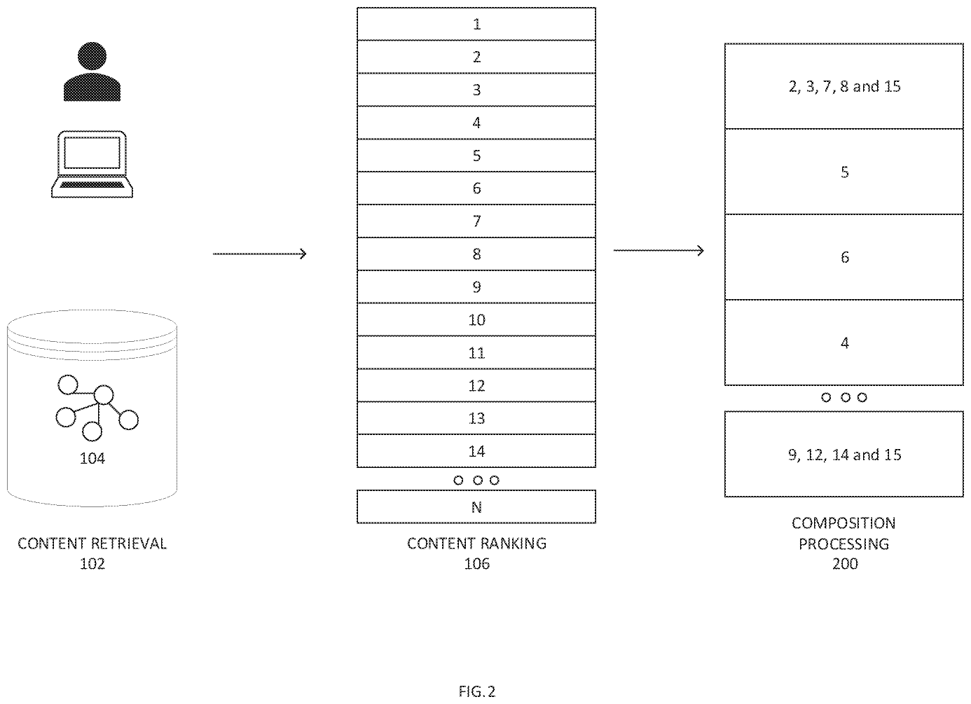

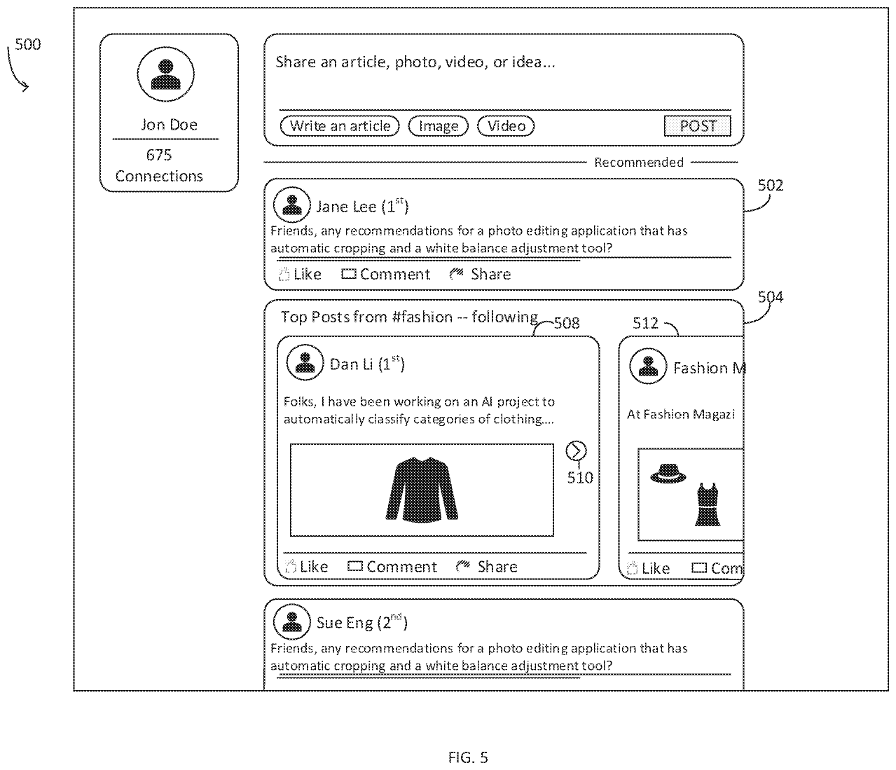

An improved technique for processing content items for presentation via a content feed is illustrated in FIG. 2. As illustrated in FIG. 2 and consistent with embodiments of the present invention, after a set of content items have been selected during the content retrieval phase 102, and the retrieved content items have been assigned a ranking score during the content ranking 106 phase, an improved composition processing algorithm is applied to generate the final positions of the content items within the content feed. During the composition processing phase 200, content items that share a certain characteristic, as memorialized in a connection graph maintained by the online service, are grouped together for presentation via a content carousel. By way of example, as illustrated in FIG. 2, the content items with ranking scores 2, 3, 7, 8 and 15 have been grouped for presentation in the highest content slot (e.g., the top position of the content feed) because those content items share a common edge within the connection graph. For example, all of the content items selected for presentation in the content carousel shown in the first content slot may be related to the same topic—a topic in which the end-user has expressed interest, for example, by electing to follow a metadata tag (e.g., a hashtag, “#fashion”)—as indicated by a tag being assigned to each content item. An example of a content feed with such a content carousel is illustrated in FIG. 5.

Consistent with some embodiments, the content feed advantageously aggregates content items that share a common edge within the connection graph. This is advantageous for at least three specific reasons. First, from the perspective of the end-user, the experience is simply better, as related content items can be consumed sequentially without interruption or distraction by other content items related to a different topic, while still maintaining a certain amount of content diversity. For instance, referring again to the example in FIG. 2, if the content items with ranking scores 2, 3, 7, 8 and 15 are all content items relating to the same topic, but shared by different end-users, the end-user viewing the content items in a content carousel can consume the content items one after another. This provides an improved end-user experience. Furthermore, aggregating content in this manner can be combined with one or more diversity rules to provide an appropriate or desired mix of aggregation and content diversity.

Second, by aggregating content items together, the composition processing step is vastly more efficient as there is less need to iteratively process and re-process the final ranked list of content items. For example, as explained above, when content diversity rules dictate that content items from the same edge within a connection graph be separated by some minimum number of unrelated content items when presented in a content feed, the processing required to satisfy such rules can be computationally expensive as the processing is iterative in nature. That is, after any one content item is repositioned, the content items within the content feed need to be analyzed a second time to make sure that moving one content item to satisfy one rule does not result in a subsequent violation of the same rule, or the violation of a different rule. By aggregating certain content items based on some shared characteristic (e.g., association with a common edge), the overall amount of processing required to enforce some set of diversity rules is significantly reduced, providing for a more efficient process, from a computational processing perspective.

Finally, because content items are grouped together consistent with embodiments of the present invention, less data is ultimately being communicated from the server that generates the content feed to the client device that displays the content feed. Specifically, because various data fields are repetitive in the content carousel, less data is required to be communicated to the client for display. By way of example, if a content carousel includes several content items that are all tagged with the same metadata tag (e.g., hashtag), this tag need only be communicated to the client one time for all content items in the content carousel. Other advantages will be readily apparent from the description of the several figures that follow.

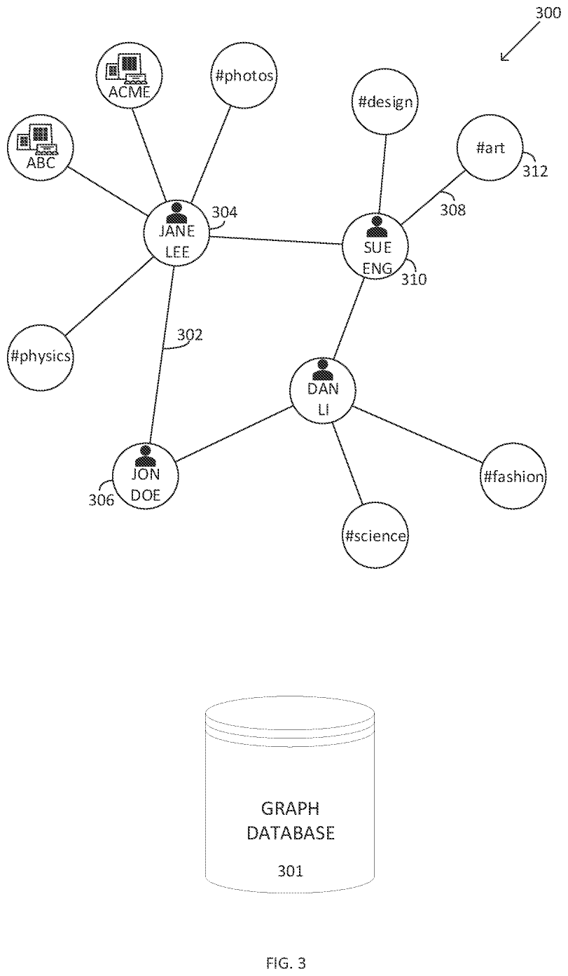

FIG. 3 is a diagram illustrating an example of a connection graph, as maintained in a database 301 as part of an online service, consistent with embodiments of the invention. The connection graph 300 is a visualization of data as stored in a database, such as the graph database 301. As shown in FIG. 3, each of the nodes in the graph are connected to at least one other node by a line, referred to herein as an edge. The data represented by each node is often referred to as an entity. Each edge represents a particular type of association or relationship between the entities represented by the nodes connected by the edge. Each node may also have or include a label (not shown), which indicates the type of entity represented by the node. Furthermore, each node and edge may have one or more properties. A property is a name-value pair that adds qualities, or otherwise characterizes, the entity represented by the node, or the relationship represented by the edge. One or more of a node's properties may be used during the ranking phase.

The types of entities represented by the nodes, as well as the various relationships represented by the edges, may vary considerably from one online service to another. By way of example and with reference to FIG. 3, a connection graph for a social networking service, often referred to as a social graph, may have nodes that represent people, companies and other organizations, as well as topics that are assigned to content. Accordingly, when one end-user of a social networking service establishes a formal connection via the service with another end-user, an edge 302 will be formed between the two nodes (e.g., 304 and 306) that represent the two end-users, indicating that the two end-users are directly connected via the connection graph 300. Note, in this context, a direct connection means that no other intermediary nodes separate the nodes representing the two end-users. In FIG. 3, the node 306 representing the end-user, “Jon Doe,” is connected by the edge 302 to the node 304 representing the end-user, “Jane Lee.” Therefore, Jon Doe and Jane Lee are connections, which means that both end-users have acknowledged their relationship formally via the social networking service. In some instances, an edge may indicate that one end-user is following another, or, following some topic. For instance, if an end-user takes some explicit action to subscribe to receive content items relating to a particular topic, an edge 308 may be created in the connection graph to indicate that the node 310 representing the end-user is associated with a node 312 representing the topic. With reference to FIG. 3, the edge 308 connecting the two nodes 310 and 312 indicates that the end-user (e.g., “Sue Eng”) has “followed” the topic associated with the hashtag, “#art.” Accordingly, any content items that have been tagged with a metadata tag associated with the particular node representing the topic, #art, will be eligible for presentation to the end-user in the personalized content feed of the end-user, and in some instances, aggregated to be presented in a group via a content carousel.

Other online services may use connection graphs that have nodes representing other types of entities, and thus, edges representing other types of associations and/or relationships. By way of example, an e-commerce or marketplace site may have nodes that represent people, categories of products, brands, and so forth. Accordingly, when a person expresses interest in a product, a category of product or a particular brand, the content feed may present product listings that are consistent with the interest(s) of the end-user. If for example an end-user purchases a product of a particular brand, a content feed may group content items—e.g., product listings—that are related to the brand, so that the content items are presented together in a group within the content feed as part of a content carousel.

Consistent with embodiments of the present invention, when an end-user is presented with his or her personalized content feed, content items that share some common characteristic as memorialized in the connection graph may be aggregated into a group, such that the content items are presented in a group, at a position in the content feed that is determined based on the highest ranking content item within the group. For instance, if five content items are all associated with a common edge in a connection graph, all five content items may be selected for presentation in a content carousel, which is then presented in a position within the content feed that is based on the highest ranking content item of the five content items. By way of example, if five content items have been tagged with the tag, “#art” 312, the end-user, Sue Eng 310, may be presented with content feed that includes a content carousel in which the five content items are presented as a group. A least with some embodiments, those content items that are aggregated for presentation in a group may be presented in a horizontally scrolling content carousel, particularly when the content feed is itself a vertically scrolling content feed. As such, in the context of a social networking service, content items that all involve content relating to the same metadata tag (e.g., hashtag) may be grouped for presentation in a common, horizontally scrolling content carousel. Similarly, in the context of an e-commerce or marketplace site, certain product listings that share some common characteristic in the connection graph—for example, product listings sharing the same edge or edge type—may be aggregated and presented in a group within the content feed.

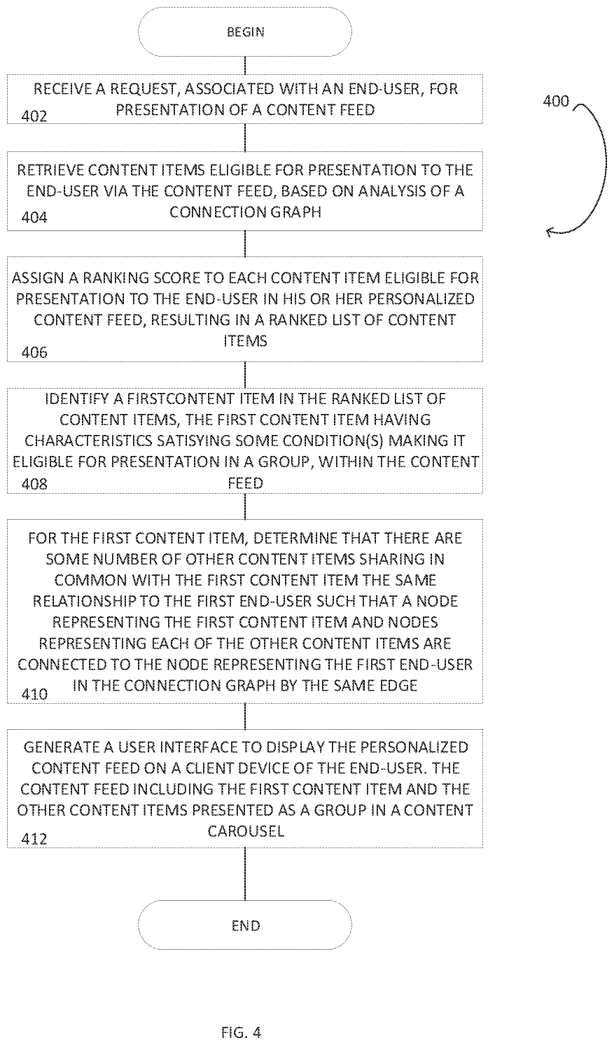

FIG. 4 is a flowchart diagram illustrating an example of the operations for selecting, processing and presenting content items in a content feed, consistent with embodiments of the invention. The method begins at operation 402 when the online service or system receives a request, associated with a specific end-user, for the presentation of the end-user's personalized content feed. This request may be the result of the end-user navigating to a particular web page associated with (e.g., hosting) his or her personalized content feed, or, invoking a mobile application associated with his or her personalized content feed. In any case, at operation 404, in response to receiving the request, the online service or system executes instructions to present a content feed to the end-user by first querying one or more databases to identify and select a variety of content items that are eligible for presentation via the content feed. As part of the content retrieval operation, a connection graph is analyzed to identify entities, represented by nodes within the connection graph, that are directly connected with the end-user on whose behalf the content feed has been requested. By way of example, a connection graph may be analyzed to determine content items that 1) have been posted by other end-users with whom the end-user is connected, 2) relate to a profile update by, or status of, another end-user with whom the end-user is connected, or 3) are associated with a particular topic that the end-user is following, as designated by a metadata tag (e.g., a hashtag) that is assigned to the content item. Of course, content items may be selected based on other characteristics associated with a connection graph, and specifically, other edges that represent different types of associations or relationships between entities represented by nodes. Accordingly, by analyzing the connection graph, the system or service can identify content items associated with various nodes that are connected by various edges to a node representing the end-user, where such content items are deemed eligible for presentation to the end-user via his or her personalized content feed.

Once the eligible content items have been identified in operation 404, at method operation 406 the eligible content items are ranked, by assigning to each content item a ranking score. In various embodiments, depending upon a variety of factors—for example, the nature of the online service and the types of entities and edges represented within the connection graph—the criteria used in ranking the content items will vary considerably. For instance, with some embodiments, some measure of the strength of connection between an end-user and a source of content (e.g., the end-user who shared a content item) may be used to rank content items. Similarly, the date and time when a content item was first published or posted may be considered when ranking content items, with preference generally being given to more recently posted content items.

After the content items are ranked, resulting in a ranked list of content items, a composition processing operation occurs to make final adjustments to the ranked list of content items before presenting the content items in a content feed. It is during this phase that some set of content items that share a common characteristic—for instance, they are all associated with or related to the end-user by means of a common edge in a connection graph—may be identified and grouped for presentation via a content carousel. For instance, at method operation 408, as part of the composition processing phase, a first content item is identified. The first step in grouping some set of content items involves identifying a first content item that satisfies some characteristic or characteristics that make it eligible for presentation in a group, via a content carousel. The first content item may be the highest ranking content item that satisfies some single characteristic, or set of characteristics. For example, only certain content items may be eligible for grouping based on a common edge in a connection graph. Accordingly, the first step in grouping a set of content items may involve identifying the top ranking content item that has characteristics satisfying whatever characteristics are used in determining which content items to group. For instance, with some embodiments, it may be the case that only certain content items are eligible for grouping, based on the nature of the edge in the connection graph that connects the node, representing the end-user, to the node associated with the particular content items. By way of example, with some embodiments, the content items eligible for grouping, based on association with a common edge, and presentation in a content carousel may include:
Content items that are associated with the same metadata tag (hashtag).
Content items indicating that an end-user has profile information satisfying some specific characteristic, such as information indicating the end-user has recently had a job anniversary, or has recently added a new job position to his or her profile.
Content items that are associated with a common source—e.g., posted by the same person, or the same company or organization.
Content items having the same explicitly defined type, such as all job postings, or, all job postings that share a common job title.
   Of course, the above list is by no means an exhaustive list, and content items having other specific characteristics may be grouped for presentation in a content carousel, consistent with embodiments of the invention. Furthermore, the above list is provided an example of the nature of content items that may be eligible for grouping in the context of a social networking service. In other contexts, where the entities represented by the nodes vary, the grouping of content items will be based on other characteristics.

Once an eligible content item has been identified, a determination is made at method operation 410 as to the number of other content items in the ranked list satisfying the same conditions—that is, sharing the same association or relationship to the node presenting the end-user as that defined by the edge connected the node, representing the end-user to the first content item. By way of example, in the context of a social networking service, it may be the case that content items that are published by or posted on behalf of an organization are eligible for presentation as a group. If the ranked list of content items includes more than some predetermined number of content items that have been posted by a company with the name, ACME Corp., and the end-user is following ACME Corp., some number of highest ranked posts published by ACME Corp. may be combined or grouped for presentation in a content carousel within the content feed. The position of the content carousel may be selected based on the highest ranking content item in the group of content items presented as part of the content carousel.

Consistent with some embodiments, content items satisfying some characteristic may be grouped only when certain conditions are satisfied. First, with some embodiments, if the end-user does not have a sufficient number of eligible content items in the ranked list of content items, no grouping of content items may be performed. For instance, if the end-user is a new user, and has not interacted with the service or system to a sufficient level, the new end-user may not have very many content items that are eligible for presentation to the end-user in a content feed. This may be the result of the end-user not having formed many connections, and as such, the end-user may not be connected to very many content items within the connection graph.

When an end-user does have a sufficient overall number of content items in the ranked list of content items, grouping content items that satisfy some edge-related characteristic may occur only when there is a number of such content items that exceeds some minimum number (e.g., five), but less than some maximum number (e.g., ten). Accordingly, as indicated at operation 410, after identifying the first content item, the system determines that there is some sufficient number of other content items sharing in common with the first content item the same association with the end-user as that identified by the edge connecting the end-user with the first content item.

Although not shown in FIG. 4, with some embodiments, after identifying some set of content items for presentation within a group, in a content carousel, other composition processing continues. For instance, with some embodiments, one or more diversity rules may be applied not only to ensure sufficient separation of similar individual content items, but also the content items being presented via a content carousel. For example, a diversity rule or condition may require that content carousels that group content items by a common graph edge be separated by some minimum number of other individual content items within the content feed.

In any case, at operation 412, after processing any additional composition rules, the content feed is generated for presentation at a client device of the end-user. Specifically, the system or services communicates information over a network from a server to a client device of the end-user, such that the information is sufficient to allow the client device to generate a user interface that includes the content feed. The content feed is presented such that those content items identified in operation 410 are included within a content carousel, as a group, such as is illustrated in FIG. 5.

FIG. 5 is a user interface diagram illustrating an example of a user interface in which a content feed is presented, consistent with embodiments of the present invention. The example user interface of FIG. 5 shows three distinct elements within a vertically scrolling content carousel. For instance, the user interface element with reference number 502 is a content item—in this instance, a graphical user interface (GUI) element referred to as a content card. As shown, the source of the content is the end-user with name, Jane Lee, who is a first-degree connection (e.g., directly connected via the social graph) of the end-user, Jon Doe, to whom the content feed is being presented. This means that Jane Lee is the end-user responsible for sharing the content item, or publishing the content item to the content feed. As Jane Lee is a first-degree connection of Jon Doe, as memorialized by an edge in the connection graph, the content item 502 is eligible for presentation within the personalized content feed that has been requested by Jon Doe.

The next content item in the content feed with reference number 504 is a horizontally scrolling content carousel for the presentation of a group of content items that share in common the same relationship with the end-user, Jon Doe, as memorialized in the connection graph. In this instance, the content carousel 504 is presenting a group of content items that all relate to the metadata tag, “#fashion,” which Jon Doe has subscribed to, or followed. Within the content carousel 504, multiple content items are accessible. As shown in FIG. 5, the highest ranking of the content items presented in the content carousel is identified with reference number 508. This content item 508 is a content posting by an end-user with name, Dan Li, who is a connection of Jon Doe. As indicated by the arrow button with reference number 510, the end-user can scroll to the right to view additional content items generally, and specifically the content card with reference number 512. The content item with reference number 512 is another content item that has been tagged with the “#fashion” hashtag.

With some embodiments, the number of content items presented within a content carousel will be based on the total number of eligible content items that share the same edge in the connection graph, so long as that number exceeds some minimum, and is not greater than some maximum. However, with other embodiments, the number of content items within a content carousel will be predetermined, and will be independent of the total number of eligible content items, so long as there are some minimum number of eligible content items. With some embodiments, when an end-user scrolls to the very last content card in the set of content items selected for presentation via the content carousel, a final content card having a link to other content items, not included within the content carousel, but having the same characteristics as those of the content items presented via the content carousel. For example, although not shown in FIG. 5, when the end-user has scrolled to the right and reached the last content card, the last content card may include a link to other content items relating to the topic designated as, “#fashion.” The link may be a link to a separate web page or user interface.

Although the example content feed of FIG. 5 is a vertically scrolling content feed having a horizontally scrolling content carousel 504, consistent with alternative embodiments of the present invention, a content feed may be a horizontally scrolling content feed.

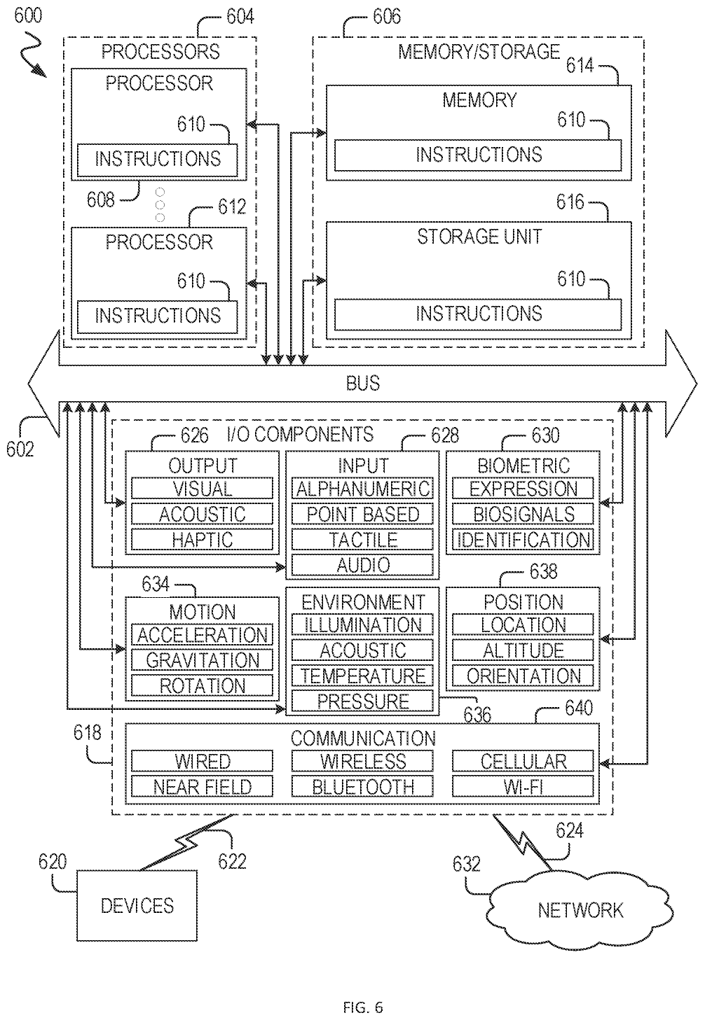

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 610 (e.g., software, a program, an application, an applet, an app, or other executable code) for causing the machine 600 to perform any one or more of the methodologies discussed herein may be executed. For example, the instructions 610 may cause the machine 600 to execute the method operations described in FIG. 4. The instructions 610 transform the general, non-programmed machine 600 into a particular machine 600 programmed to carry out the described and illustrated functions in the manner described.

In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a switch, a controller, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 610, sequentially or otherwise, that specify actions to be taken by the machine 600. Further, while only a single machine 600 is illustrated, the term “machine” shall also be taken to include a collection of machines 600 that individually or jointly execute the instructions 610 to perform any one or more of the methodologies discussed herein.

The machine 600 may include processors 604, memory/storage 606, and I/O components 618, which may be configured to communicate with each other such as via a bus 602. In an example embodiment, the processors 604 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 608 and a processor 612 that may execute the instructions 610. The term “processor” is intended to include multi-core processors that may comprise two or more independent processors (sometimes referred to as “cores”) that may execute instructions contemporaneously. Although FIG. 6 shows multiple processors 604, the machine 600 may include a single processor with a single core, a single processor with multiple cores (e.g., a multi-core processor), multiple processors with a single core, multiple processors with multiples cores, or any combination thereof.

The memory/storage 606 may include a memory 614, such as a main memory, or other memory storage, and a storage unit 616, both accessible to the processors 604 such as via the bus 602. The storage unit 616 and memory 614 store the instructions 610 embodying any one or more of the methodologies or functions described herein. The instructions 610 may also reside, completely or partially, within the memory 614, within the storage unit 616, within at least one of the processors 604 (e.g., within the processor's cache memory), or any suitable combination thereof, during execution thereof by the machine 600. Accordingly, the memory 614, the storage unit 616, and the memory of the processors 604 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 610. The term “machine-readable medium” shall also be taken to include any medium, or combination of multiple media, that is capable of storing instructions (e.g., instructions 610) for execution by a machine (e.g., machine 600), such that the instructions, when executed by one or more processors of the machine (e.g., processors 604), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 618 may include a wide variety of components to receive input, provide output, produce output, transmit information, exchange information, capture measurements, and so on. The specific I/O components 618 that are included in a particular machine will depend on the type of machine. For example, portable machines such as mobile phones will likely include a touch input device or other such input mechanisms, while a headless server machine will likely not include such a touch input device. It will be appreciated that the I/O components 618 may include many other components that are not shown in FIG. 6. The I/O components 618 are grouped according to functionality merely for simplifying the following discussion, and the grouping is in no way limiting. In various example embodiments, the I/O components 618 may include output components 626 and input components 628. The output components 626 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 628 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 618 may include biometric components 630, motion components 634, environmental components 636, or position components 638 among a wide array of other components. For example, the biometric components 630 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 634 may include acceleration sensor components (e.g., accelerometer), gravitation sensor components, rotation sensor components (e.g., gyroscope), and so forth. The environmental components 636 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 618 may include communication components 640 operable to couple the machine 600 to a network 632 or devices 620 via a coupling 624 and a coupling 622, respectively. For example, the communication components 640 may include a network interface component or other suitable device to interface with the network 632. In further examples, the communication components 640 may include wired communication components, wireless communication components, cellular communication components, Near Field Communication (NFC) components, Bluetooth®, components (e.g., Bluetooth) Low Energy), Wi-Fi® components, and other communication components to provide communication via other modalities. The devices 620 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geo-location, location via Wi-Fi® signal triangulation, location via detecting an NFC beacon signal that may indicate a particular location, and so forth.

In various example embodiments, one or more portions of the network 632 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 632 or a portion of the network 632 may include a wireless or cellular network and the coupling 624 may be a Code Division Multiple Access (CDMA) connection, a Global System for Mobile communications (GSM) connection, or another type of cellular or wireless coupling. In this example, the coupling 624 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks. Universal Mobile Telecommunications System (UNITS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 610 may be transmitted or received over the network 632 using a transmission medium via a network interface device (e.g., a network interface component included in the communication components 640) and utilizing any one of a number of well-known transfer protocols (e.g., HTTP). Similarly, the instructions 610 may be transmitted or received using a transmission medium via the coupling 622 (e.g., a peer-to-peer coupling) to the devices 620. The term “transmission medium” shall be taken to include any intangible medium that is capable of storing, encoding, or carrying the instructions 610 for execution by the machine 600, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
responsive to receiving a request associated with a first end-user of an online service for presentation of a personalized, vertically scrolling content feed, retrieving from a database a plurality of content items eligible for presentation to the first end-user via the vertically scrolling content feed, each content item in the plurality of content items selected based on the content item having a relationship to the first end-user as memorialized by an edge connecting a first node, representing the first end-user, to a second node, associated with a respective content item in a connection graph maintained by the online service;
assigning to each content item in the plurality of content items a ranking score;
for a first content item, determining that there are some predetermined minimum number of other content items sharing in common with the first content item the same relationship to the first end-user such that a node representing the first content item and nodes representing each of the other content items are connected to the node representing the first end-user in the connection graph by the same edge; and
generating a user interface to display the personalized, vertically scrolling content feed on a client-device of the first end-user, wherein content items are presented in the vertically scrolling content feed in a position relative to one another based on the ranking score assigned to each content item, and the first content item and some predetermined number of the other content items are presented as a group in a horizontally scrolling content carousel at a position in the vertically scrolling content feed that is based on the ranking score of the first content item.

2. The computer-implemented method of claim 1, wherein the first content item has a higher ranking score than each of the predetermined number of other content items, such that the position of the horizontally scrolling content carousel in the vertically scrolling content feed is based on the highest ranking content item of all content items being presented in the horizontally scrolling content carousel.

3. The computer-implemented method of claim 1, wherein each content item presented in the horizontally scrolling content carousel is presented as a separate graphical user interface (GUI) element, wherein one additional content item is added to the group of content items presented via the horizontally scrolling content carousel, the one additional content item providing a link, which, when selected by the first end-user, causes presentation of a separate user interface displaying one or more additional content items sharing in common with the first content item the same relationship to the first end-user.

4. The computer-implemented method of claim 1, wherein each content item in the plurality of content items is designated as having a particular content type, and the first content item is selected based on the first content item having been assigned the highest ranking score for a specific content type.

5. The computer-implemented method of claim 4, wherein each content item presented in the horizontally scrolling content carousel is a content item to which a metadata tag has been assigned, the metadata tag indicating the content item is related to a particular topic in which the first end-user of the online service has previously indicated an interest by virtue of having taken some explicit action to follow the particular topic associated with the metadata tag.

6. The computer-implemented method of claim 4, wherein each content item presented in the horizontally scrolling content carousel is a content item that has been shared by a second end-user with whom the first end-user is connected, as denoted in the connection graph maintained by the online service.

7. The computer-implemented method of claim 4, wherein each content item presented in the horizontally scrolling content carousel is a system-generated content item relating to an update concerning information in a profile of an end-user.

8. The computer-implemented method of claim 7, wherein the update concerning information in the profile of an end-user is information indicating a recent change made to the profile of the end-user indicating a new employment position for the end-user.

9. A system comprising:
at least one processor;
a computer-readable storage medium storing instructions thereon, which, when executed by the at least one processor, cause the system to:
receive a request associated with a first end-user of an online service for presentation of a personalized, vertically scrolling content feed;
retrieve from a database a plurality of content items eligible for presentation to the first end-user via the vertically scrolling content feed, each content item in the plurality of content items selected based on the content item having a relationship to the first end-user as memorialized by an edge connecting a first node, representing the first end-user, to a second node, associated with a respective content item in a connection graph maintained by the online service;
assigning to each content item in the plurality of content items a ranking score;
for a first content item, determining that there are some predetermined minimum number of other content items sharing in common with the first content item the same relationship to the first end-user such that a node representing the first content item and nodes representing each of the other content items are connected to the node representing the first end-user in the connection graph by the same edge; and
generating a user interface to display the personalized, vertically scrolling content feed on a client-device of the first end-user, wherein content items are presented in the vertically scrolling content feed in a position relative to one another based on the ranking score assigned to each content item, and the first content item and some predetermined number of the other content items are presented as a group in a horizontally scrolling content carousel at a position in the vertically scrolling content feed that is based on the ranking score of the first content item.

10. The system of claim 9, wherein the first content item has a higher ranking score than each of the predetermined number of other content items, such that the position of the horizontally scrolling content carousel in the vertically scrolling content feed is based on the highest ranking content item of all content items being presented in the horizontally scrolling content carousel.

11. The system of claim 9, wherein each content item presented in the horizontally scrolling content carousel is presented as a separate graphical user interface (GUI) element, wherein one additional content item is added to the group of content items presented via the horizontally scrolling content carousel, the one additional content item providing a link, which, when selected by the first end-user, causes presentation of a separate user interface displaying one or more additional content items sharing in common with the first content item the same relationship to the first end-user.

12. The system of claim 9, wherein each content item in the plurality of content items is designated as having a particular content type, and the first content item is selected based on the first content item having been assigned the highest ranking score for a specific content type.

13. The system of claim 12, wherein each content item presented in the horizontally scrolling content carousel is a content item to which a metadata tag has been assigned, the metadata tag indicating the content item is related to a particular topic in which the first end-user of the online service has previously indicated an interest by virtue of having taken some explicit action to follow the particular topic associated with the metadata tag.

14. The system of claim 12, wherein each content item presented in the horizontally scrolling content carousel is a content item that has been shared by a second end-user with whom the first end-user is connected, as denoted in the connection graph maintained by the online service.

15. The system of claim 12, wherein each content item presented in the horizontally scrolling content carousel is a system-generated content item relating to an update concerning information in a profile of an end-user.

16. The system of claim 12, wherein the update concerning information in the profile of an end-user is information indicating a recent change made to the profile of the end-user indicating a new employment position for the end-user.

17. A computer-implemented method comprising:
responsive to receiving a request associated with a first end-user of a social networking service for presentation of a personalized content feed, retrieving from a database a plurality of content items eligible for presentation to the first end-user via the content feed, each content item in the plurality of content items selected based on the content item being associated with a node in a connection graph that is directly connected with a node representing the end-user;
assigning to each content item in the plurality of content items a ranking score, resulting in a ranked list of content items;
identifying a first content item within the ranked list of content items that satisfies a condition indicating that the first content item is eligible for presentation, via a content carousel, with a group of other content items satisfying the same condition;
determining that there are some predetermined minimum number of other content items satisfying the same condition satisfied by the first content item, wherein the condition involves the first content item being associated with the end-user by a particular type of edge connecting nodes in a connection graph maintained by the social networking service; and
generating a user interface to display the personalized content feed on a client-device of the end-user, wherein content items are presented in the content feed in a position relative to one another based on the ranking score assigned to each content item, and the first content item and some predetermined number of the other content items are presented as a group in a content carousel at a position in the content feed that is based on the ranking score of the first content item.
